(19) United States
(12) Patent Application Publication
(10) Pub. No.: US 2017/0082755 A1
(43) Pub. Date: Mar. 23, 2017

(54) LOW COST, FLEXIBLE SPACE GPS RECEIVER TECHNOLOGY DEVELOPMENT PLATFORM

(71) Applicant: U.S.A. as represented by the Administrator of the National Aeronautics and Space Administration, Washington, DC (US)

(72) Inventors: LUKE J. THOMAS, Ellicott City, MD (US); LUKE WINTERNITZ, Greenbelt, MD (US); MONTHER A. HASOUNEH, Silver Spring, MD (US); HARRY E. STELLO, Laurel, MD (US); JENNIFER VALDEZ, Takoma Park, MD (US); SAMUEL R. PRICE, Baltimore, MD (US)

(21) Appl. No.: 14/858,832

(22) Filed: Sep. 18, 2015

(51) Int. Cl. G01S 19/37

(52) U.S. Cl. CPC G01S 19/37

(57) ABSTRACT

A Field Programmable Gate Array (FPGA) evaluation board may include a firmware/software architecture that facilitates easier prototyping of new GPS receiver designs. A single reprogrammable FPGA with an integrated soft processor and spare logic resources may be targeted to expand the GPS receiver design. The system may operate on an FPGA evaluation board with the ability to integrate easily with various types of analog/radio frequency (RF) hardware. A hardware platform with a variety of connections to a computer may be utilized to be able to read telemetry from the receiver and analyze the performance.

### STATEMENT OF FEDERAL RIGHTS

The invention described herein was made by employees of the United States Government and may be manufactured and used by or for the Government for Government purposes without the payment of any royalties thereon or therefore.

### FIELD

The present invention generally relates to development platforms, and more particularly, to a Field Programmable Gate Array (FPGA)-based Global Positioning System (GPS) development platform with ports and a firmware/software architecture that facilitates rapid prototyping of new GPS receiver designs for various GPS receivers.

### BACKGROUND

Space GPS receiver design is a highly specialized field. Due to this fact and to the cost of space-rated electronics, space GPS receivers tend to be expensive. This may also be true for development platforms that target a specific flight platform. Furthermore, such development platforms may be constrained by the final flight design, making it difficult to extend the design. Accordingly, a low cost space GPS development platform that provides very high flexibility and a path to flight may be beneficial.

### SUMMARY

Certain embodiments of the present invention may provide solutions to the problems and needs in the art that have not yet been fully identified, appreciated, or solved by conventional flight development platforms. For example, some embodiments of the present invention pertain to a low cost FPGA evaluation board with a firmware/software architecture that facilitates easier prototyping of new GPS receiver designs, while providing a path to a flight space GPS receiver implementation.

In an embodiment, an FPGA evaluation board includes an FPGA running GPS firmware flight code. The FPGA includes an integrated soft processor running GPS receiver flight software. The GPS receiver flight software is configured to operate a navigation system on a space vehicle. The FPGA also includes spare logic resources to expand a GPS receiver flight design. The FPGA integrates with a plurality of different types of analog/RF hardware and tests functionality of the plurality of different types of analog/RF hardware via the GPS receiver firmware and software.

In another embodiment, an evaluation board includes an FPGA running Global Positioning System (GPS) firmware and navigation software configured to implement a GPS receiver. The evaluation board also includes an FMC connector and a PCI Express connector allowing for integration with a variety of GPS analog front ends. The FPGA evaluation board is configured to receive a plurality of different types of GPS signals via the FMC connector, the PCIe connector, or both.

In yet another embodiment, an apparatus includes an FPGA running GPS firmware flight code and GPS receiver flight software configured to control a GPS receiver. The apparatus also includes an FMC connector and a PCI Express connector allowing for integration with a variety of GPS analog front ends. The FPGA includes spare logic resources to expand a GPS receiver design. The FPGA tests functionality of a plurality of different types of GPS receivers.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating consolidation of processing resources to a single reprogrammable chip, according to an embodiment of the present invention.

FIG. 2 is a block diagram illustrating a GPS L1 receiver using an FMC connector with a commercial daughter card, according to an embodiment of the present invention.

FIG. 3 is a block diagram illustrating a GPS L1 receiver 310 using a PCI Express (PCIe) connector with an external front end, according to an embodiment of the present invention.

FIG. 4 is a block diagram illustrating a GPS L1/L2C receiver using an FPGA Mezzanine Card (FMC) connector with a custom interface card, according to an embodiment of the present invention.

FIG. 5 is a block diagram illustrating telemetry interfaces, according to an embodiment of the present invention.

### DETAILED DESCRIPTION OF THE EMBODIMENTS

Some embodiments of the present invention pertain to a low cost FPGA evaluation board with a system-on-a-chip architecture that facilitates easier prototyping of new GPS receiver designs. For instance, some embodiments may cost approximately $2,000. Such a low cost implementation may be distributed to universities and other entities that may not be able to afford a more expensive system.

The evaluation board may assist with, and speed up, the intermediate evaluation step between GPS receiver design and the final space flight platform. A single reprogrammable FPGA with an integrated soft processor and spare logic resources may be targeted to expand the GPS receiver design. The firmware may be derived from a heritage flight system, and may further provide a direct path to a new space flight system. A developer may add new firmware and recode software running on the processor for different receivers, to accommodate hardware changes, to add new capabilities, etc. The system may operate on an FPGA evaluation board with the ability to integrate easily with various types of analog/radio frequency (RF) hardware through standard connectors. A hardware platform with a variety of connections to a computer may be utilized to be able to read telemetry from the receiver and analyze the performance.

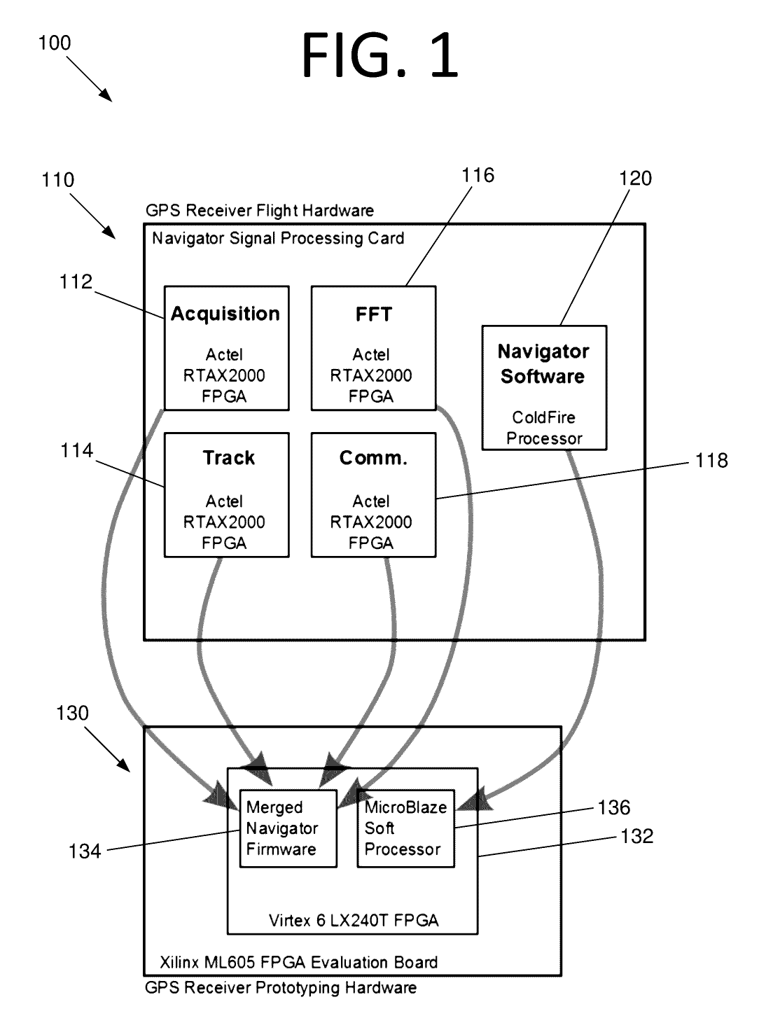

FIG. 1 is a block diagram 100 illustrating consolidation of processing resources from a Navigator flight hardware signal processing card 110 to a single reprogrammable chip prototyping card 132, according to an embodiment of the present invention. In Navigator signal processing card 110, four FPGAs 112, 114, 116, and 118 are used for acquisition, tracking, Fast Fourier Transforms (FFT), and communications, respectively. An external ColdFire™ processor runs the Navigator software.

However, in single reprogrammable chip 132 (in this case, a Virtex 6 LX240T™ FPGA), the firmware from the four different FPGAs 112, 114, 116, 118 of signal processing card 110 is merged into merged firmware 134. In addition, the software that was running on an external ColdFire™ processor 120 is migrated to run on an FPGA internal soft processor 136, (i.e., the Microblaze™ processor). The receiver tracks and acquires signals using a combination of software and firmware. Single reprogrammable chip 132 is on an FPGA evaluation board 130 (i.e., a Xilinx ML605™ FPGA evaluation board). However, different boards, FPGAs, and or processors may be used in other embodiments without deviating from the scope of the invention.

The new firmware architecture shown in FIG. 1 has been demonstrated on the Xilinx ML605™ evaluation board with three different analog/RF front end systems: (1) a GPS L1 receiver using an FMC connector with a commercial daughter card; (2) a GPS L1 receiver using a PCIe connector with an external front end; and (3) a GPS L1/L2C receiver using an FMC connector with a custom RF card. However, other analog/RF front end systems may be used without deviating from the scope of the invention. The architecture is expandable to other applications, including processing of modernized GNSS signals (GPS L2C and L5, Galileo, GLONASS, and COMPASS), XNAV signal processing, and more.

GPS L1 Receiver Using FMC Connector with Commercial Daughter Card

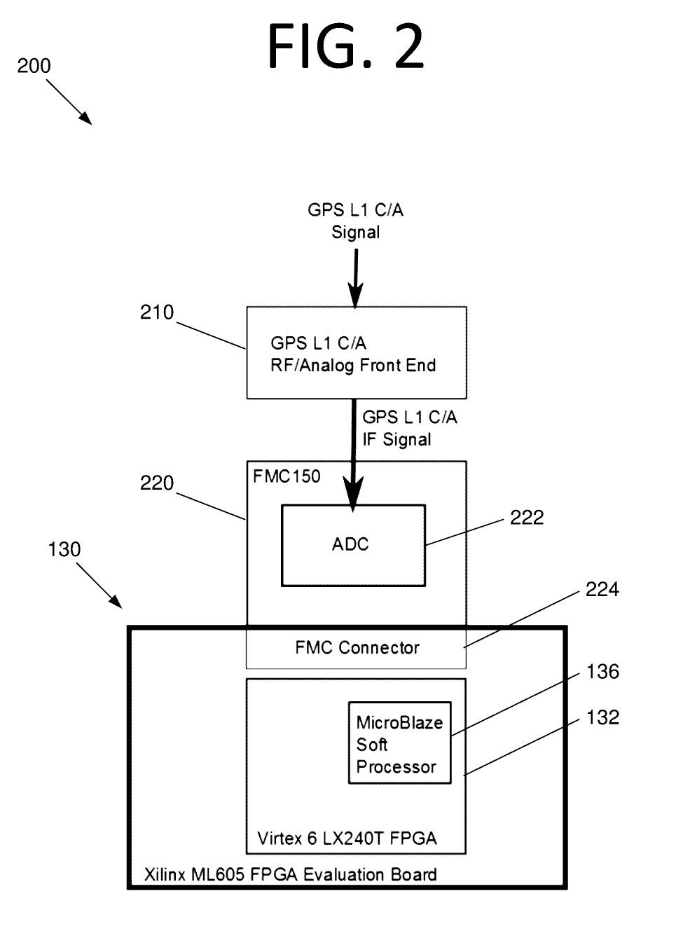

FIG. 2 is a block diagram illustrating a GPS L1 receiver 200 using an FMC connector 224 with a commercial daughter card 220, according to an embodiment of the present invention. An external GPS L1 C/A RF/analog front end box 310 receives a GPS L1 C/A signal, applies the appropriate gain, and downconverts the signal to an intermediate frequency (IF) GPS L1 C/A signal. The IF signal feeds into a FPGA Mezzanine Card (FMC) 220 which contains an Analog-to-Digital Converter (ADC) 222. ADC 222 samples cross FMC connector 224 to FPGA 132 on FPGA evaluation board 130.

GPS L1 Receiver using PCIe Connector with External Front End

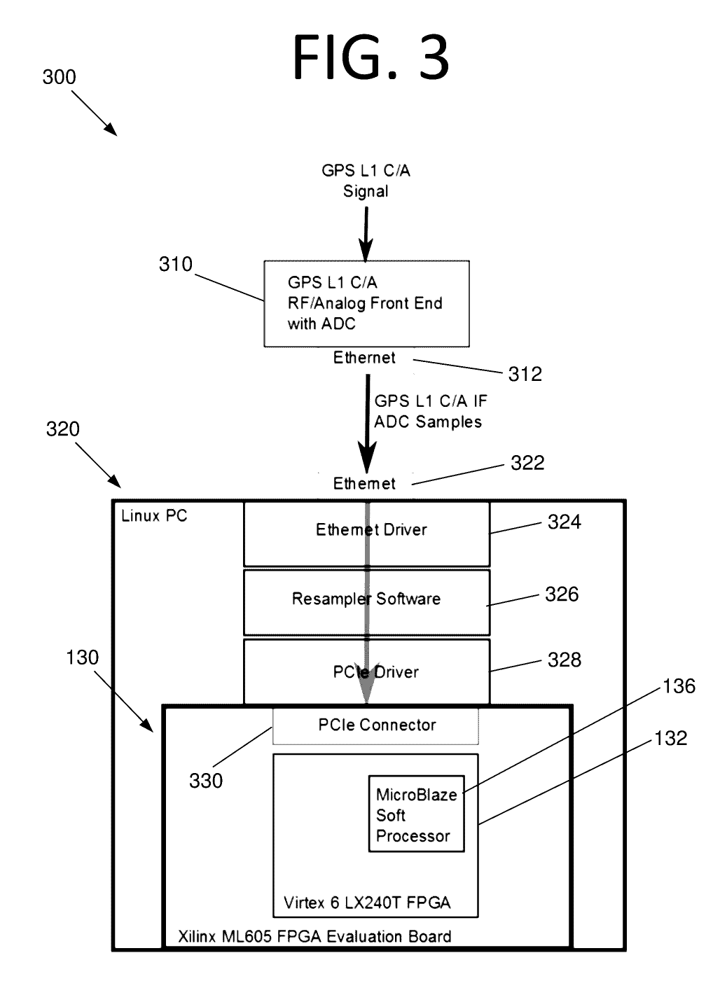

FIG. 3 is a block diagram illustrating a GPS L1 receiver 300 using a PCIe connector 330 with an external front end 310, according to an embodiment of the present invention. External GPS RF front end box 310 receives the GPS L1 C/A signal, applies the appropriate gain, downconverts the signal to an IF frequency, digitizes it with an ADC, and transmits the ADC samples over Ethernet 312. The ADC samples are received by an Ethernet card 322 installed on Linux™ PC 320. Resampler software 326 running on Linux PC 320 reads the samples from Ethernet card 322 provided by Ethernet driver 324 and transmits the samples to FPGA evaluation board 130 that is installed in a PCI express slot (not shown) on Linux PC 320. Here, a PCIe connector 330 receives the samples from a PCIe driver 328 and provides the samples to FPGA 132.

GPS L1/L2C Receiver using FMC Connector with Custom RF Card

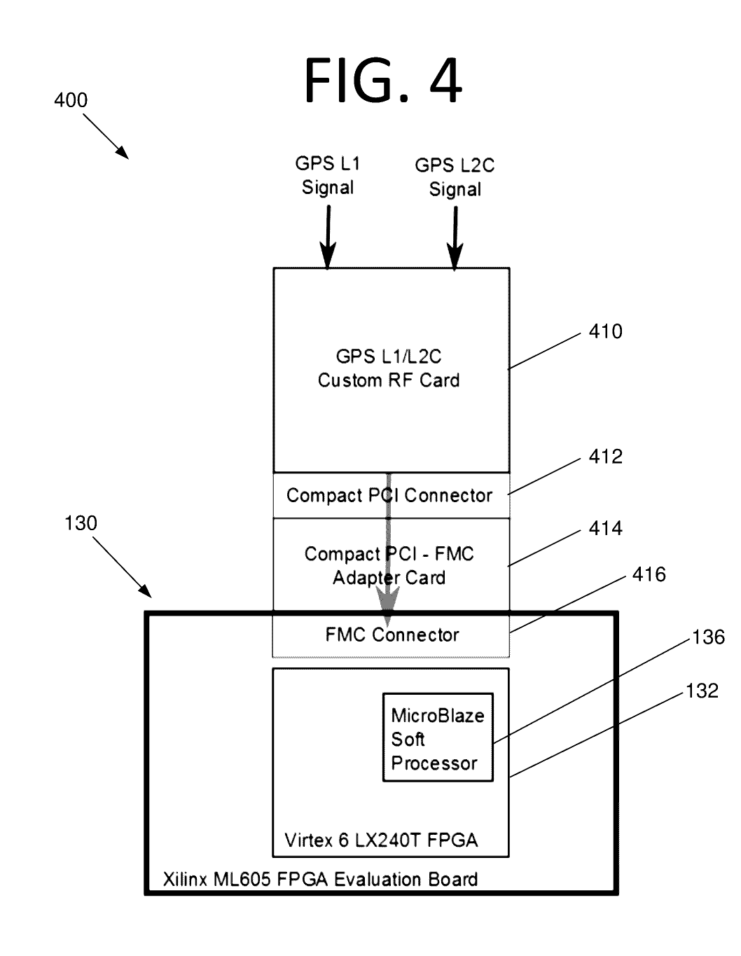

FIG. 4 is a block diagram illustrating a GPS L1/L2C receiver 400 using an FMC connector 416 with a custom interface card 410, according to an embodiment of the present invention. External custom RF front end card 410 receives the GPS L1 C/A and L2C signals, applies the appropriate gain, downconverts the signals to an IF frequency, and digitizes the IF with ADCs. The ADC samples are then sent over a compact PCI backplane connector 412 to an FMC adapter card 414 that routes the signal to FMC connector 416 on FPGA evaluation board 130.

Telemetry Interfaces

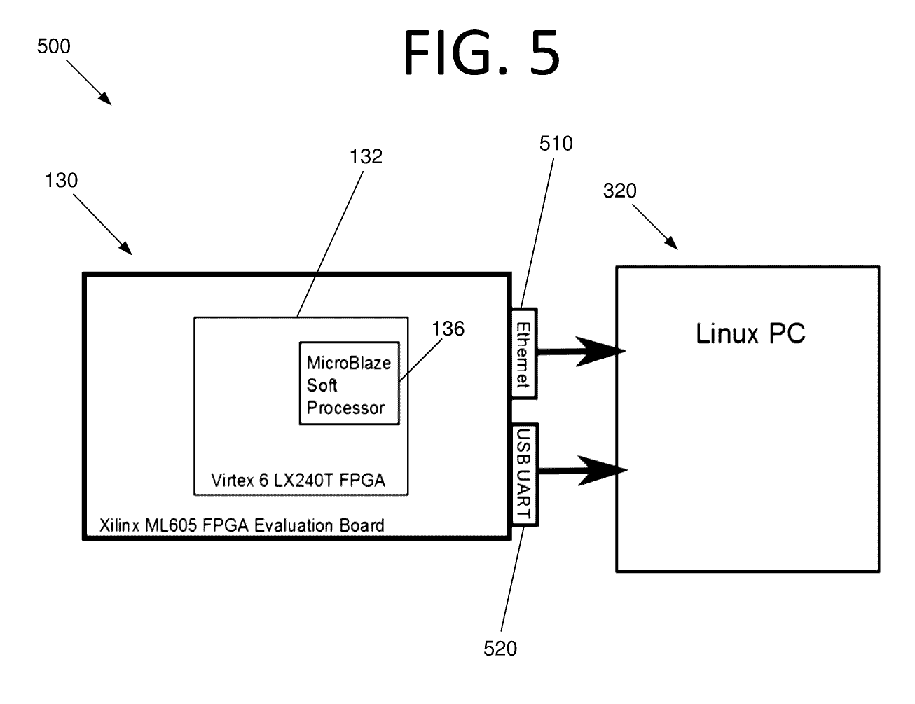

FIG. 5 is a block diagram illustrating telemetry interfaces 500, according to an embodiment of the present invention. In this embodiment the GPS receiver design exploits two external interfaces on FPGA evaluation board 130—a gigabit Ethernet port 510 and UART serial port 520. Gigabit Ethernet port 510 connects to PC 320 using an Ethernet card (not shown) and UART serial port 520 connects to PC 320 via a USB port (not shown). Both interfaces may be used to forward telemetry and debug information from the GPS receiver design in order to more rapidly and easily prototype new designs.

The use of multiple connectors on the evaluation board, such as FMC and PCIe, for example, increases the flexibility of the board for testing multiple GPS receiver types and designs. With such an architecture, the evaluation board may be used to connect to and test a variety of different GPS receivers without reengineering the board itself. This flexibility is shown in FIGS. 2-4, for example, and does not exist in typical GPS receiver flight prototypes.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A Field Programmable Gate Array (FPGA) evaluation board, comprising:
an FPGA running Global Positioning System (GPS) firmware flight code, wherein
the FPGA comprises:
an integrated soft processor running GPS receiver flight software, the GPS receiver flight software configured to operate a navigation system on a space vehicle, and
spare logic resources to expand a GPS receiver flight design, and
the FPGA integrates with a plurality of different types of analog/radio frequency (RF) hardware and tests functionality of the plurality of different types of analog/RF hardware via the GPS receiver firmware and software.

2. The FPGA evaluation board of claim 1, wherein the analog/RF hardware comprises a GPS L1 receiver using a FPGA Mezzanine Card (FMC) connector with a daughter card, a GPS L1 receiver using a PCIe connector with an external front end, and/or a GPS L1/L2C receiver using an FMC connector with a custom RF card.

3. The FPGA evaluation board of claim 1, wherein the FPGA evaluation board is configured to process modernized GNSS signals, XNAV signal processing, or both.

4. The FPGA evaluation board of claim 1, further comprising:
a FPGA Mezzanine Card (FMC) connector that receives a digital GPS L1 C/A signal from a FMC.

5. The FPGA evaluation board of claim 1, further comprising:
a PCIe connector configured to connect to a PCIe slot on a computer, wherein
the PCIe connector receives GPS L1 C/A samples from a PCIe driver on the computer.

6. The FPGA evaluation board of claim 1, further comprising:
a gigabit Ethernet port, a UART serial port, or both.

7. The FPGA evaluation board of claim 6, wherein the FPGA evaluation board is configured to forward telemetry and debug information to a computer using the gigabit Ethernet port, the UART serial port, or both.

8. The FPGA evaluation board of claim 1, wherein the firmware is configured to control data acquisition, tracking, and communication.

9. An evaluation board, comprising:
a Field Programmable Gate Array (FPGA) running Global Positioning System (GPS) firmware and navigation software configured to implement a GPS receiver;
a FPGA Mezzanine Card (FMC) connector and a PCIe connector, allowing integration with a variety of GPS analog front ends, wherein
the FPGA evaluation board is configured to receive a plurality of different types of GPS signals via the FMC connector, the PCIe connector, or both.

10. The evaluation board of claim 9, wherein the firmware is configured to control data acquisition, tracking, and communication.

11. The evaluation board of claim 9, wherein the GPS receiver comprises a GPS L1 receiver using a FPGA Mezzanine Card (FMC) connector with a daughter card, a GPS L1 receiver using a PCIe connector with an external front end, and/or a GPS L1/L2C receiver using an FMC connector with a custom RF card.

12. The evaluation board of claim 9, wherein the evaluation board is configured to process modernized GNSS signals, XNAV signal processing, or both.

13. The evaluation board of claim 9, wherein the FMC connector receives a digital GPS L1 C/A signal from a FMC.

14. The evaluation board of claim 1, wherein the PCIe connector receives GPS L1 C/A samples from a PCIe driver on a computer.

15. The evaluation board of claim 1, further comprising:
a gigabit Ethernet port, a UART serial port, or both, wherein
the evaluation board is configured to forward telemetry and debug information to a computer using the gigabit Ethernet port, the UART serial port, or both.

16. An apparatus, comprising:
a Field Programmable Gate Array (FPGA) running Global Positioning System (GPS) firmware and GPS receiver flight software configured to control a GPS receiver;
a FPGA Mezzanine Card (FMC) connector and a PCIe connector, allowing integration with a variety of GPS analog front ends, wherein
the FPGA comprises spare logic resources to expand a GPS receiver design,
the FPGA tests functionality of a plurality of different types of GPS receivers.

17. The apparatus of claim 16, wherein the firmware is configured to control data acquisition, tracking, and communication.

18. The apparatus of claim 16, wherein the GPS receiver comprises a GPS L1 receiver using a FPGA Mezzanine Card (FMC) connector with a daughter card, a GPS L1 receiver using a PCIe connector with an external front end, and/or a GPS L1/L2C receiver using an FMC connector with a custom RF card.

19. The apparatus of claim 16, wherein the apparatus is configured to process modernized GNSS signals, XNAV signal processing, or both.

20. The apparatus of claim 16, further comprising:
a gigabit Ethernet port, a UART serial port, or both, wherein
the evaluation board is configured to forward telemetry and debug information to a computer using the gigabit Ethernet port, the UART serial port, or both.
